(19) United States
(12) Patent Application Publication
(10) Pub. No.: US 2006/0075227 A1
(43) Pub. Date: Apr. 6, 2006

(54) Portable information management device

(76) Inventor: Jeom Jin Park, Irvine, CA (US)

Correspondence Address: JEOM JIN PARK, 26 Cambridge, Irvine, CA, 92620, US

(21) Appl. No.: 10/959,443

(22) Filed: Oct. 5, 2004

(51) Int. Cl. H04L 9/00; G06F 12/14; H04L 9/32; G06F 11/30

(52) U.S. Cl. 713/167; 713/193

(57) ABSTRACT

A personal information management (PIM) device receives personal information such as user IDs, passwords, bank account information, credit card information, uniform resource locators (URLs) and the like, from a data input device and stores the information in the memory module. However, prior to storing the information in the memory module, an encryption/decryption module encrypts the information to be stored thereby creating secured information in the memory module.

### 1. FIELD OF THE INVENTION

The present invention relates to personal information management apparatus and methods.

### 2. BACKGROUND OF THE INVENTION

Many users are registered in various websites as members with different ID's and passwords. Further, with the advent of e-commerce, many products and services are available for purchase through the various websites using credit card information, bank information and the like.

However, such personal information is subject to theft and made vulnerable when stored in a computer. For example, the personal information stored in a computer may be subject to hacking. Further, if a public accessible computer is used to access websites, it is unknown whether the public accessible computer is secure. For example, there may be spyware lurking within the computer that is gathering personal information being entered so that it can send the information to an identity thief at a later time.

### SUMMARY OF THE INVENTION

A personal information management (PIM) device receives personal information such as user IDs, passwords, bank account information, credit card information, uniform resource locators (URLs) and the like, from a data input device and stores the information in the memory module. However, prior to storing the information in the memory module, an encryption/decryption module encrypts the information to be stored thereby creating secured information in the memory module.

### BRIEF DESCRIPTION OF THE DRAWINGS

Various exemplary embodiments of the invention are described in detail, with reference to the following figures, wherein:

FIG. 1 illustrates an exemplary environment in which a personal information management (PIM) device 100 may be utilized;

FIG. 2 illustrates an exemplary PIM device 100;

FIG. 3 illustrates an exemplary operation of the PIM device 100 when connected to a device;

FIG. 4 illustrates an exemplary agent module;

FIG. 5 illustrates an exemplary PIM device that includes a clock feature and be in a form of a watch with a USB connection port;

FIG. 6 is a flow diagram of an exemplary operation of a PIM device; and

FIG. 7 is a flow diagram of an exemplary operation of an agent.

### DETAILED DESCRIPTION

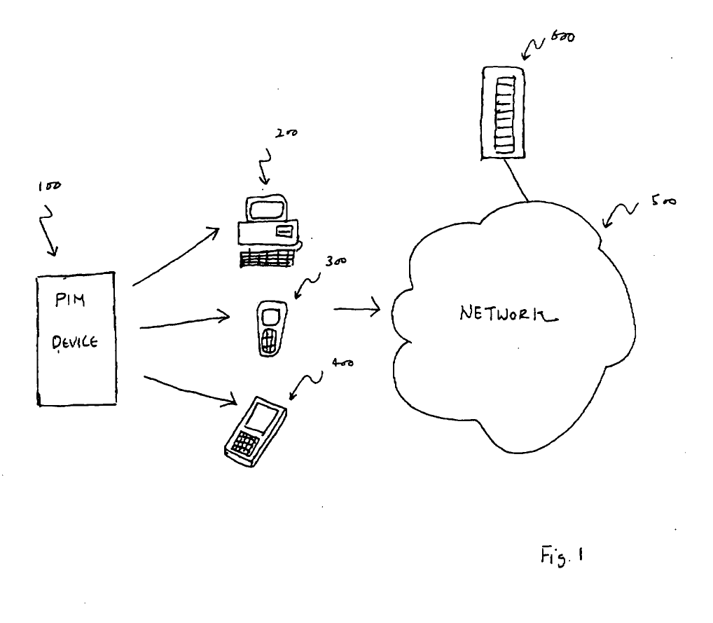

FIG. 1 illustrates an exemplary environment in which a personal information management (PIM) device 100 may be utilized. As shown in the figure, the PIM device 100 may be coupled by wire or wirelessly to a device such as a computer 200, a cellular phone 300 or a personal digital assistant (PDA) 400 and the like. The computer 200 may be coupled to a network 500 by wire. The network 500 may be the Internet or a private network. The cellular phone 300 may be connected to a network wirelessly. The PDA 400 may be connected to a network by wire or wirelessly depending on the mode of connection. The network 500 may be connected to a network server 600, which services the devices 200, 300 and 400 connected to the network 500 to access other devices, servers and the like.

For example, a user of the PIM device 100 may want to use the computer 200 to connect to a website accessible through the network server 600. However, because the computer 200 is unsecured, the user may not want to store or use the computer's resources to enter and process sensitive information such as user ID, password and the like required for access to the website. Further, the user may not want to store credit card information nor bank account information and the like in the computer 200.

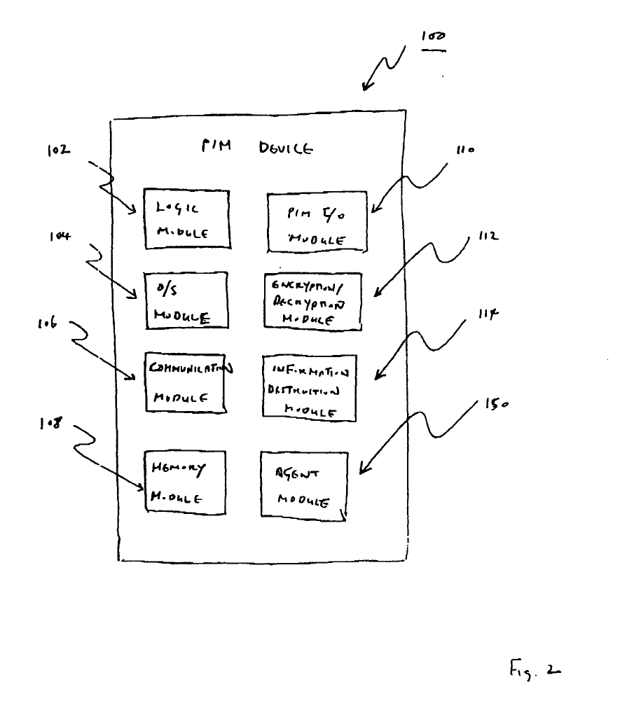

FIG. 2 illustrates an exemplary PIM device 100 in accordance with an embodiment of the invention. The PIM device 100 includes a logic module 102, an operating system module 104, a communication module 106, a memory module 108, a PIM device input/output module 110, an encryption/decryption module 112, an information destruction module 114 and an agent module 150. The operating system module 104 includes instructions, which when executed by the logic module 102, controls the overall operation of the PIM device 100. The control operations include the management of the memory module 108 and the control operation of the communication module 106 so that the communication module 106 may communicate with a device connected to the network 500. The control operations also include the control operations of the PIM device input/output module 110, the encryption/decryption module 112, the information destruction module 114 and the agent module 150.

The PIM device input/output module 110 may interface the PIM device 100 to a device. When prompted by the logic module 102, the PIM device input/output module 110 receives information such as user IDs, passwords, bank account information, credit card information, uniform resource locators (URLs) and the like, from a data input device (not shown) and stores the information in the memory module 108. However, prior to storing the information in the memory module 108, the encryption/decryption module 112 encrypts the information to be stored thereby creating secured information in the memory module 108.

When a module or device requests information stored in the memory module 108, the information requesting module or device makes the request to the logic module 102 through the PIM device input/output module 110. The logic module 102 prompts the memory module 108 with a memory address location to retrieve the requested information. The logic module 102 then forwards the information, but in encrypted form, to the PIM device input/output module 110. The PIM device input/output module 110 then forwards the information to the requesting module or device. It should be appreciated that because the information is encrypted, only the module or device with a counterpart decryption module can decrypt and utilize the encrypted information.

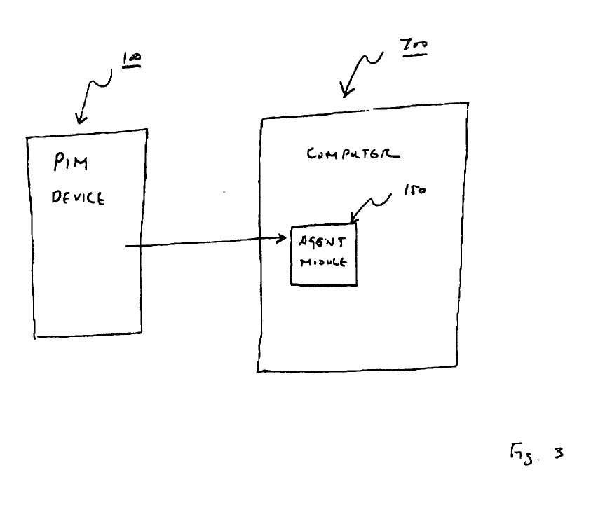

Various known encryption methods may be used such as Triple-DES, SEED and the like. The information may be stored in database format in the memory module, however to conserve memory space, information may be stored as files. The information destruction module 114 and the agent module 150 will be described with respect to FIG. 3.

FIG. 3 illustrates an exemplary operation of the PIM device 100 when connected to a device, for example, a computer 700 having access to a network. The PIM device 100 may be connected to the computer 700 via a Universal Serial Bus (USB) port, IEEE 1394 serial bus, Bluetooth and the like. It should be appreciated that if the USB port is used to connect the PIM device 100 to the computer 700, because the USB port is capable of providing power, no power source may be required in the PIM device 100. Instead, the PIM device 100 utilizes the power source provided by the USB port. In this instance, a more compact and economical PIM device 100 may be produced. It should be appreciated that in this configuration it is desirable that the memory module 108 uses flash memories or the like so that information stored in the memory module 108 does not become lost when the PIM device 100 is disconnected from the USB port.

When the PIM device 100 is connected to the computer 700, the computer's operating system is assumed to recognize the connection of the PIM device 100 via the plug-n-play feature. The operating system then registers the PIM device 100 as a peripheral device connected to the computer 700. The PIM device 100 then automatically or by user command launches the agent module 150 into the computer 700 via the USB port. The agent module 150 provides the interface between the computer 700 and the PIM device 100. The agent module 150 may reside in the volatile memory of the computer 700 and may be terminated when the user ends the computer session. Alternatively, the agent module 150 may be stored in a permanent memory of the computer 700 for current and future use.

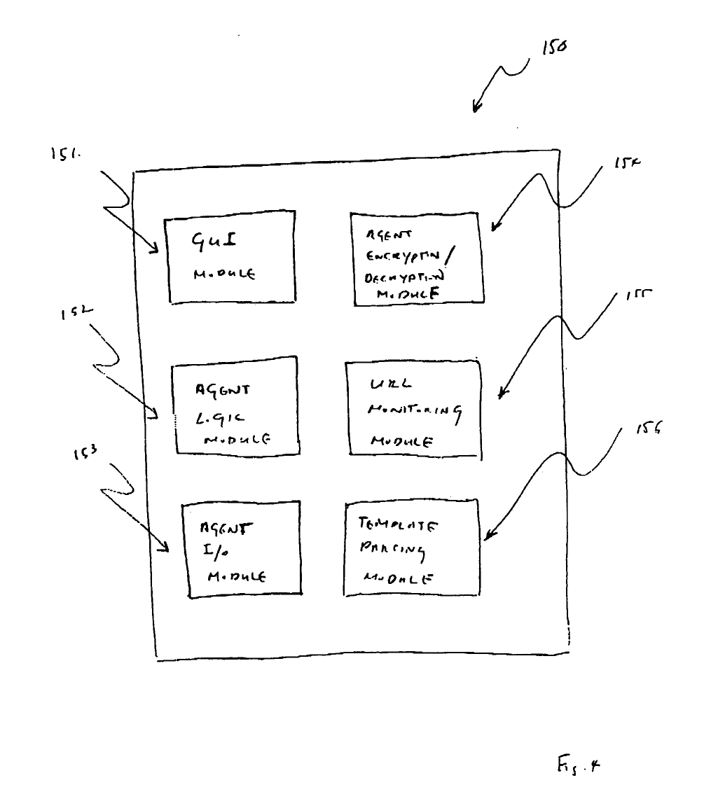

With references to both FIGS. 3 and 4, the agent module 150 includes a graphic user interface (GUI) module 151, an agent logic module 152, an agent input/output module 153, an agent encryption/decryption module 154, a URL monitoring module 155 and a template parsing module 156. The GUI module 151 allows a user to interact with the PIM device 100 via the computer 700. For instance, when the user wants to access the information in the memory module 108, the user may issue a command through the GUI, which usually appears on a display of the computer 700. Initially, the GUI may prompt the user to enter user ID and password to access the PIM device 100. The agent logic module 102 receives the user ID and password and forwards the entries to the encryption/decryption module 154. The encryption/decryption module 154 encrypts the user ID and the password. The logic module 102 then forwards the encrypted entries to the agent input/output module 153, which forwards the encrypted entries to the PIM device 100.

The PIM device input/output module 110 receives the encrypted entries and forwards the entries to the PIM device encryption/decryption module 112, which decrypts the encrypted entries. Then the logic module 102 compares the decrypted user ID and password with a previously stored user ID and password. If there is a match, the logic module via the PIM device input/output module 110 informs the agent module 150 that the user is authorized to access the information stored in the memory module 108. However, if there is no match, the logic module 102 may cause the agent module 150 to prompt the user to re-enter the user ID and password. The information destruction module 114 keeps track of the number of times the user ID and/or the password is entered in one session that does not match the previously stored user ID and password in the PIM device 100. If a predetermined number of mismatch occurs, the information destruction module 114 destroys all information stored in the memory module 108.

Once the user is authorized to have access to the information stored in the memory module 108, the user may then surf the network for websites that the user wants to access using the computer's web browser. For example, the user may want to access a website that sells goods. The URL monitoring module 155 of the agent module 150 monitors the URL address that the user is accessing. For example, when the user enters the website's homepage, the URL monitoring module 155 forwards the URL of the website's homepage to the PIM device 100. The PIM device input/output module 110, upon receiving the URL address, which may be encrypted, decrypts the URL address and forwards the URL address to the logic module 102.

The logic module 102 then searches the memory module 108 to determine whether the memory module 108 has previously stored a URL address that matches the URL address forwarded by the agent module 150. If there is a match, the logic module 102 retrieves the pertinent information associated with the URL address from the memory module 108 and forwards the information to the agent module 150. As discussed above, the retrieved information is encrypted. The agent input/output module 153 receives the encrypted information and forwards the encrypted information to the agent encryption/decryption module 154 to be decrypted.

If information for access to the website is available, then the template parsing module 156 parses the website's homepage to determine the format in which the information is to be entered into the website's homepage. Because the homepage is usually created using a metadata language such as HTML, XML and the like, the template parsing module 156 parses the homepage to determine the format in which the information is to be entered. The template parsing module 156 then enters the information in the proper format in the homepage of website. The user then entering a return key, for example, becomes authorized to browse through the website.

The user may purchase one or more items at the website. Once the user has made the item selections, the user may open the payment transaction webpage. The payment transaction webpage may request for credit card information and user information such as home address to which the items may be shipped. The user may interact with the PIM device 100 to obtain the pertinent information. For instance, the user may open the GUI and using a pointing device, such as a mouse, click a button titled “credit cards” in a menu of the GUI. The agent module 150 communicates with the PIM device 100 to obtain a list of credit cards. The user may then select one of credit cards for use in purchasing the items. The user selection causes the PIM module 100 to retrieve the credit card information from the memory and forward the information to the agent module 150. Because the information is encrypted, the agent module 150 uses the agent encryption/decryption module 154 to decrypt the information. Then the template parsing module 156 matches the credit card information to the credit card information entries in the payment transaction webpage. The user may further add the shipping information to the shipping information entries in the payment transaction webpage. When all the pertinent information has been entered in the payment transaction webpage, the user enters a “return” key to complete the transaction. When the user is finished with the transaction, the user may close the GUI and disconnect the PIM device 100 from the computer 700. Alternatively, the user may go to another website to repeat the process.

It should be appreciated that based on the principles above, secured e-mail may be sent and received using the PIM device 100. For example, received e-mails may be encrypted and stored in the memory module 108. Further all communication between an e-mail website and the user is conducted through the agent module 150. Thus, the e-mail interchange is not registered nor recorded within the computer 700 or its memories.

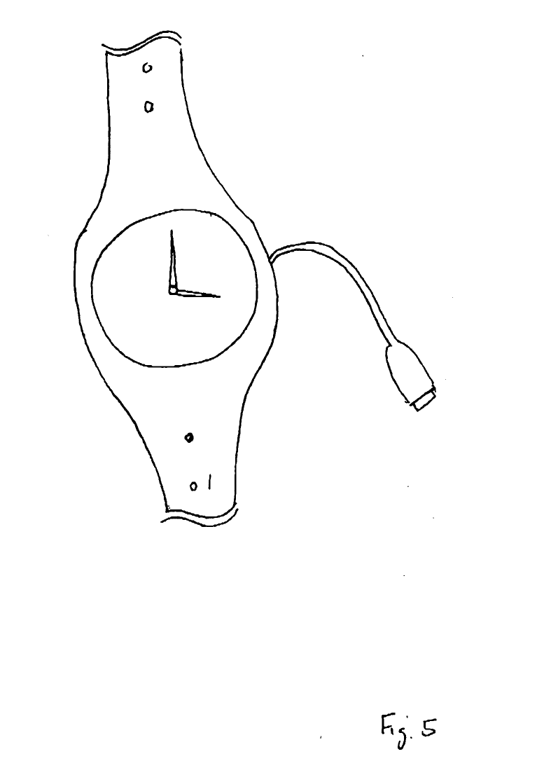

The PIM device 100 may include other features and be in a form that is wearable on the user. For example, as shown in FIG. 5, the PIM device may include a clock feature and be in a form of a watch with a USB connection port. Other features that may be included are a calendar for personal scheduling, a world clock, a calculator, a radio, and the like.

Although an exemplary embodiment of the invention has been explained using a website that sells goods, it should be appreciated that the present invention may be used in any websites that prompt for certain data entry prior to allowing access to the website or complete a transaction. For examples, these websites may include, an online banking accounts, online brokerage accounts, e-mail accounts and the like.

When connected, personal information sent and received by the PIM device is encrypted. It should be appreciated that all information transmitted between the agent module and the PIM module is encrypted, thus any hacker or identity thief that intercepts the information will not be able to use the information because they do not have access to the decryption module. Further, personal information stored in the PIM device's memory module is encrypted. Because personal information is not stored in the temporary and permanent memories of the computer, a potential hacker does not have access to the personal information. The personal information stored in the memory module of PIM device is encrypted, and thus, a potential hacker having access to the PIM device is not able to obtain the personal information contents.

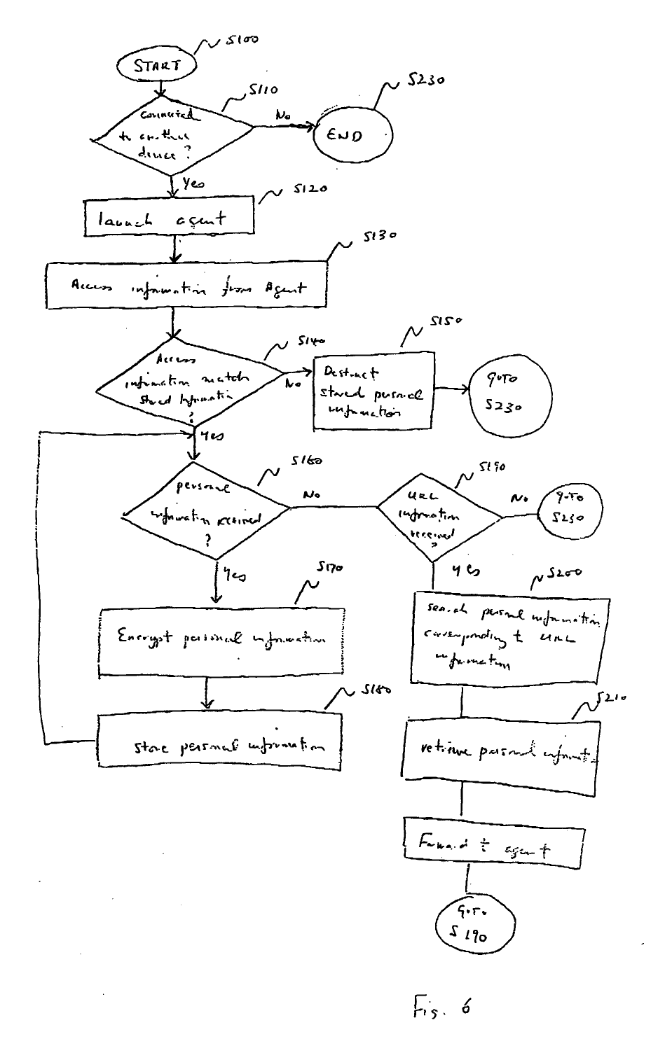

FIG. 6 is a flow diagram of an exemplary operation of a PIM device. The operation starts at step S100 and continues to step S110 where a determination is made whether a connection has been made with another device. If a connection has not been made, then the operation continues to step S230 to end the operation. If a connection has been made to another device, then at step S120, an agent is launched to reside in the another device. Then at step S130, access information is received from the agent. At step S140, a determination is made whether the access information matches a stored information for a predetermined number of times. If the access information does not match the stored information after a predetermined number of times, then the operation continues to step S150 where the stored personal information is destroyed. The operation then continues to step S230 where the operation ends.

Otherwise, if the access information matches the stored information, then the operation continues to step S160. At step S160, a determination is made whether personal information has been received from the agent. If the personal information has been received from the agent, then the operation continues to step S170 where the personal information is encrypted. Then at step S180, the encrypted personal information is stored. The operation then continues to step S160. Otherwise, if there is no personal information received, then the operation continues to step S190.

At step S190, a determination is made whether URL information has been received from the agent. If no URL information has been received from the agent, then the operation continues to step S230 where the operation ends. Otherwise, if URL information has been received, then the operation continues to step S200 where personal information corresponding to the URL information is searched. At step S210, the corresponding personal information is retrieved from storage. At step S220, the personal information is forwarded to the agent. The operation then continues to step S190.

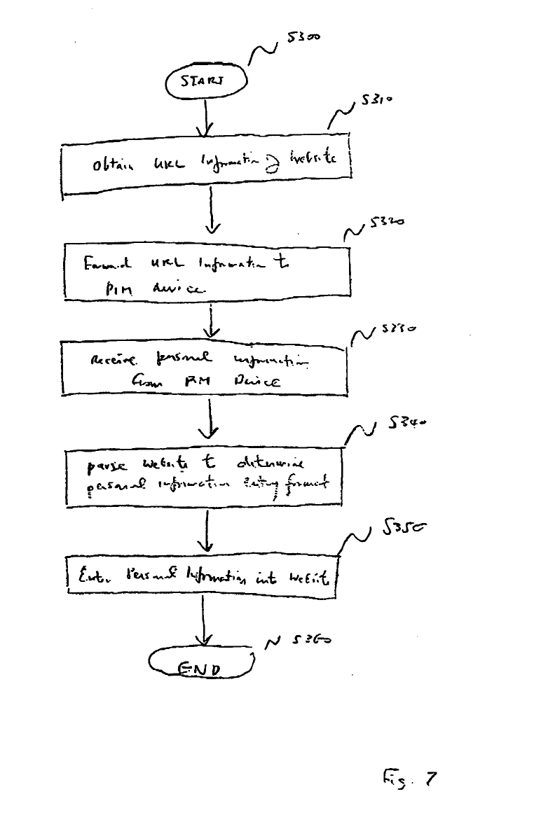

FIG. 7 is a flow diagram of an exemplary operation of an agent. The operation starts at step S300 and continues to step S310 where URL information of a website is obtained. Then at step S320, the URL information is forwarded to the PIM device. At step S330, encrypted personal information corresponding to the URL information is received. At step S340, the website is parsed to determine personal information entry format. Then at step S350, personal information is entered into the website according to the determined personal information entry format. The operation then continues to step S360 where the operation ends.

In various exemplary embodiments outlined above, the PIM device may be implemented using a programmed microprocessor, a microcontroller, peripheral integrated circuit elements, an application specific integrated circuit (ASIC) or other integrated circuit, a hardwired electronic or logic circuit such as discrete element circuit, a programmable logic devices such as PLD, PLA, FPGA or PAL, and the like. In various embodiments, the various modules may be devices capable of implementing a finite state machine, software routines or instructions, and the like. Further, the flow diagrams of FIGS. 6 and 7 may be implemented as computer executable mediums.

Depending on the configuration of the PIM device 100, personal information, website bookmark, e-mail accounts, website group, bank information, credit card information, address book, and the like may be stored.

In various embodiments, the agent module is not launched into a device connected to a network, but remains within the PIM device and operates as part of the PIM module.

While the invention has been described in conjunction with the exemplary embodiments outlined above, it is evident that many alternatives, modifications and variations will be apparent to those skilled in the art. Accordingly, the exemplary embodiments of the invention, as set forth above, are intended to be illustrative and not limiting. Various changes may be made without departing from the spirit and scope of the invention.

What is claimed is:

1. An apparatus for securing information, comprising:
a first input/output module that receives/transmits information;
a first encryption/decryption module that encrypts/decrypts received information; and
a memory module that stores encrypted information, wherein the apparatus is portable to a user.

2. The apparatus of claim 1, further comprising:
an information destruction module that destructs encrypted information stored in the memory module if access is denied a predetermined number of times.

3. The apparatus of claim 1, further comprising:
an agent module that includes a graphic user interface (GUI) module that provides an interface between the user and the apparatus.

4. The apparatus of claim 3, further comprising:
a communication port which is connectable to a device.

5. The apparatus of claim 4, wherein when the communication is connected to the device, the agent module is launched from the apparatus to reside in the device.

6. The agent module of claim 4, further comprising:
a second input/output module that transmits/receives information with the first input/output module of the apparatus; and
a second encryption/decryption module that encrypts/decrypts the transmitted/received information of the first input/output module.

7. The agent module of claim 6, further comprising:
a uniform resource locator (URL) module that monitors a URL addressed by a browser residing in the device.

8. The agent module of claim 7, further comprising:
a template parsing module that parses a website addressed by the URL, and thereby determines information entry format of the website.

9. The apparatus of claim 1, wherein the apparatus is wearable on the user and includes at least one of a calendar for personal scheduling, a clock, a world clock, a calculator and a radio.

10. A method for securing information, comprising:
encrypting information; and
storing the encrypted information in a memory.

11. The method of claim 10, further comprising:
monitoring access information; and
destructing the encrypted information stored in the memory if the access information does not correspond with prestored information after a predetermined number of attempts.

12. The method of claim 10, further comprising:
connecting to a device; and
launching an agent into the device.

13. The method of claim 12, further comprising:
using the agent to generate a graphic user interface (GUI) at a display of the device, the GUI providing access to the memory.

14. The method of claim 13, further comprising:
using the agent to monitor a URL addressed by a browser residing in the device, and
causing encrypted information to be retrieved that allows for access to a website addressed by the URL.

15. The method of claim 14, further comprising:
using the agent to decrypt the retrieved encrypted information.

16. The method of claim 14, further comprising:
parsing the website addressed by the URL, and thereby obtaining information on access information entry format.

17. A computer executable medium which when executed by a computer performs the method of claim 10.

18. A computer executable medium which when executed by a computer performs the method of claim 11.

19. An apparatus for securing information, comprising:
means for encrypting information; and
means for storing encrypted information in a memory.

20. The apparatus for securing information, further comprising:
means for monitoring access information; and
means for destructing the encrypted information stored in the memory if the access information does not correspond with prestored information after a predetermined number of attempts.
